(19) United States
(12) Patent Application Publication
(10) Pub. No.: US 2015/0025040 A1
(43) Pub. Date: Jan. 22, 2015

(54) NOVEL POLYMORPHS OF FOSAMPRENAVIR CALCIUM

(71) Applicant: HETERO RESEARCH FOUNDATION, Hyderabad, Andhra Pradesh (IN)

(72) Inventors: Bandi Parthasaradhi Reddy, Hyderabad (IN); Kura Rathnakar Reddy, Hyderabad (IN); Dasari Muralidhara Reddy, Hyderabad (IN); Kesireddy Subash Chander Reddy, Hyderabad (IN); Bandi Vamsi Krishna, Hyderabad (IN)

(21) Appl. No.: 14/125,386

(22) PCT Filed: May 21, 2012
(86) PCT No.: PCT/IN2012/000361

§ 371 Date: Jan. 2, 2014

(30) Foreign Application Priority Data
Jun. 14, 2011 (IN) 2011/CHE/2011

(51) Int. Cl. C07F 9/655

(52) U.S. Cl. CPC C07F 9/65515; C07B 2200/13
USPC 514/99; 549/222

(57) ABSTRACT

Crystalline Forms of fosamprenavir calcium are disclosed, processes for its preparation and pharmaceutical compositions therefrom. The process for the preparation of fosamprenavir calcium crystalline Form H1, comprises: a) suspending fosamprenavir calcium in a nitrile solvent; b) heating the suspension obtained in step (a) at reflux; c) optionally adding a solvent to the reaction mass obtained in step (b); d) cooling the reaction mass at below 35 degrees Centigrade; and e) isolating fosamprenavir calcium crystalline Form H1. Another process for the preparation of substantially pure amorphous fosamprenavir calcium, which comprises: a) dissolving fosamprenavir calcium in an ester solvent; b) a portion of solvent from the solution obtained in step (a) until at least separation of fosamprenavir calcium as solid occurs; and c) isolating substantially pure amorphous fosamprenavir calcium. The pharmaceutical composition may comprse substantially pure amorphous fosamprenavir calcium and pharmaceutically acceptable excipients.

This application claims the benefit of Indian Patent Application No. 2011/CHE/2011, filed Jun. 14, 2011, which is incorporated herein by reference.

### FILED OF THE INVENTION

The present invention provides a novel crystalline Form of fosamprenavir calcium, process for its preparation and pharmaceutical compositions comprising it. The present invention also provides substantially pure amorphous fosamprenavir calcium, process for its preparation and pharmaceutical compositions comprising it.

### BACKGROUND OF THE INVENTION

Fosamprenavir calcium is chemically, (3S)-tetrahydrofuran-3-yl (1S,2R)-3-[[(4-aminophenyl)sulfonyl](isobutypamino]-1-benzyl-2-(phosphonooxy)propylcarbamate monocalcium salt and has the structural formula:

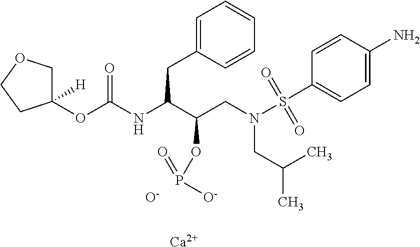

Fosamprenavir calcium is a prodrug of amprenavir, an inhibitor of HIV protease. It is useful in combination with other antiretroviral agents for the treatment of human immunodeficiency virus (HIV-1) infection. Fosamprenavir calcium is currently marketed under the trade name LEXIVA® by VIIV HLTHCARE.

Fosamprenavir calcium and its process were disclosed in U.S. Pat. No. 6,436,989.

Polymorphism is defined as “the ability of a substance to exist as two or more crystalline phases that have different arrangement and/or conformations of the molecules in the crystal Lattice. Thus, in the strict sense, polymorphs are different crystalline structures of the same pure substance in which the molecules have different arrangements and/or different configurations of the molecules”. Different polymorphs may differ in their physical properties such as melting point, solubility, X-ray diffraction patterns, etc. Although those differences disappear once the compound is dissolved, they can appreciably influence pharmaceutically relevant properties of the solid form, such as handling properties, dissolution rate and stability. Such properties can significantly influence the processing, shelf life, and commercial acceptance of a polymorph. It is therefore important to investigate all solid forms of a drug, including all polymorphic forms, and to determine the stability, dissolution and flow properties of each polymorphic form. Polymorphic forms of a compound can be distinguished in the laboratory by analytical methods such as X-ray diffraction (XRD), Differential Scanning calorimetry (DSC) and Infrared spectrometry (IR).

Solvent medium and mode of crystallization play very important role in obtaining one polymorphic Form over the other.

Fosamprenavir calcium can exist in different polymorphic Forms, which may differ from each other in terms of stability, physical properties, spectral data and methods of preparation.

U.S. Pat. No. 6,514,953 disclosed fosamprenavir calcium crystalline Form I, characterized by an X-ray powder diffraction pattern having peaks expressed as 2θ at about 5.735, 9.945, 11.500, 13.780, 14.930, 15.225, 17.980, 19.745, 21.575, 22.170, 24.505 and 27.020 degrees.

PCT publication no. WO 2010/134045 disclosed amorphous fosamprenavir calcium. Crystalline Form II of fosamprenavir calcium was disclosed in PCT publication no. WO 2011/001383.

U.S. application publication no. 2011/0165202 disclosed a rod like amorphous form of Fosamprenavir calcium. The publication also described crystalline Form II, Form III, Form IV and Form P of fosamprenavir calcium.

We have found a novel crystalline Form of fosamprenavir calcium. The novel crystalline Form has been found to be stable over the time and reproducible and so, suitable for pharmaceutical preparations.

We have also found substantially pure amorphous fosamprenavir calcium. The novel amorphous Form has been found to be stable over the time and reproducible and so, suitable for pharmaceutical preparations. The present invention comprises a non-rod like amorphous Form of fosamprenavir calcium salt.

Thus, one object of the present invention is to provide a novel crystalline Form of fosamprenavir calcium, process for its preparation and pharmaceutical compositions comprising it.

Another object of the present invention is to provide substantially pure amorphous fosamprenavir calcium, process for its preparation and pharmaceutical compositions comprising it.

### SUMMARY OF THE INVENTION

In one aspect, the present invention provides a crystalline Form of fosamprenavir calcium designated as Form H1 characterized by peaks in the powder x-ray diffraction spectrum having 2θ angle positions at about 4.4, 5.0, 6.2 and 8.9±0.2 degrees.

In another aspect, the present invention provides a process for the preparation of fosamprenavir calcium crystalline Form H1, which comprises:
a) suspending fosamprenavir calcium in a nitrile solvent;
b) heating the suspension obtained in step (a) at reflux;
c) optionally adding a solvent to the reaction mass obtained in step (b);
d) cooling the reaction mass at below 35° C.; and
e) isolating fosamprenavir calcium crystalline Form H1.

In another aspect, the present invention provides a pharmaceutical composition comprising crystalline Form H1 of fosamprenavir calcium and pharmaceutically acceptable excipients.

In another aspect, the present invention provides substantially pure amorphous fosamprenavir calcium.

In another aspect, the present invention provides a process for the preparation of substantially pure amorphous fosamprenavir calcium, which comprises:
a) dissolving fosamprenavir calcium in an ester solvent;
b) a portion of solvent from the solution obtained in step (a) until at least separation of fosamprenavir calcium as solid occurs; and
c) isolating substantially pure amorphous fosamprenavir calcium.

Yet in another aspect, the present invention provides pharmaceutical composition comprising substantially pure amorphous fosamprenavir calcium and pharmaceutically acceptable excipients.

### BRIEF DESCRIPTION OF THE DRAWINGS

FIG. 1 shows an X-Ray Powder Diffractogram of fosamprenavir calcium crystalline Form H1.

FIG. 2 shows an X-Ray Powder Diffractogram of substantially pure amorphous fosamprenavir calcium.

FIG. 3 shows a SEM (Scanning Electron Microscope) image of substantially pure amorphous fosamprenavir calcium in magnification 10.5 mm×5000.

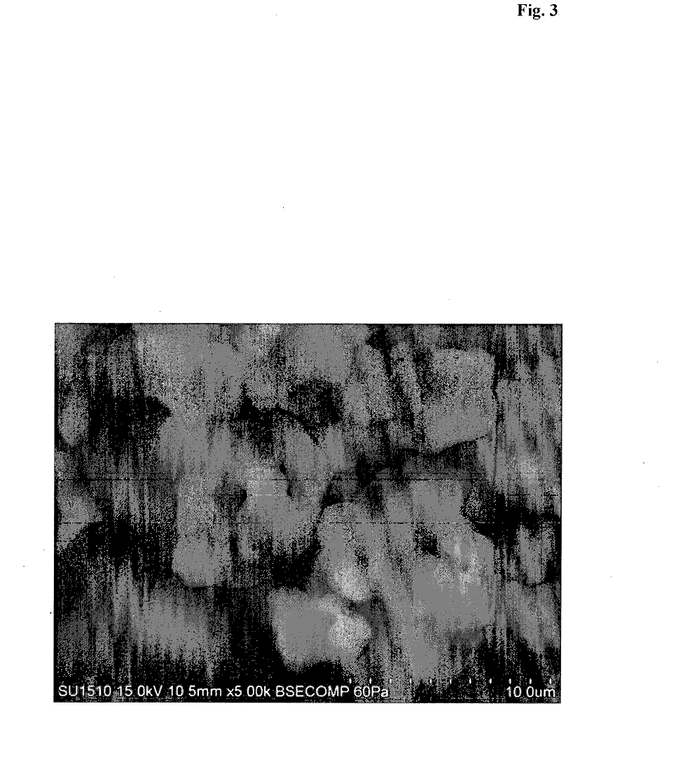

FIG. 4 shows a SEM image of substantially pure amorphous fosamprenavir calcium in magnification 10.5 mm×2000.

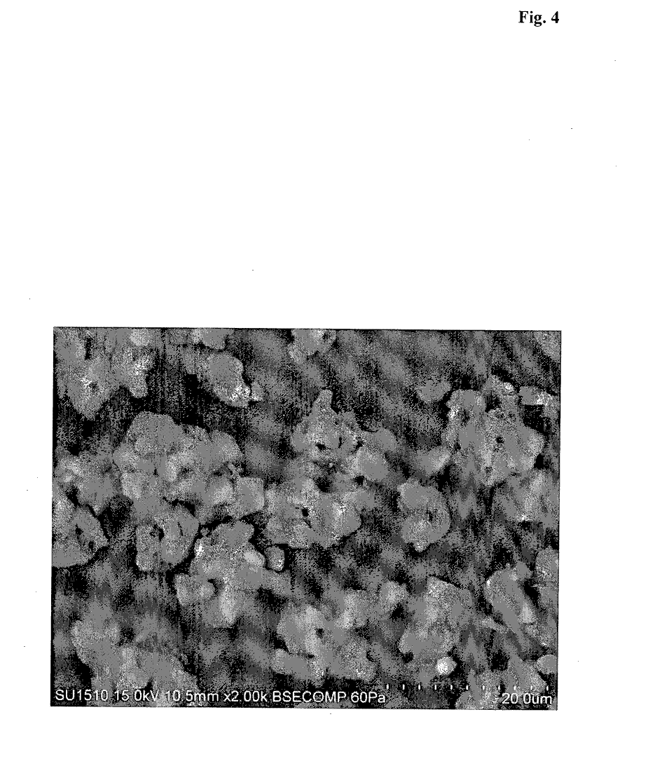

FIG. 5 shows a SEM image of substantially pure amorphous fosamprenavir calcium in magnification 10.4 mm×2000.

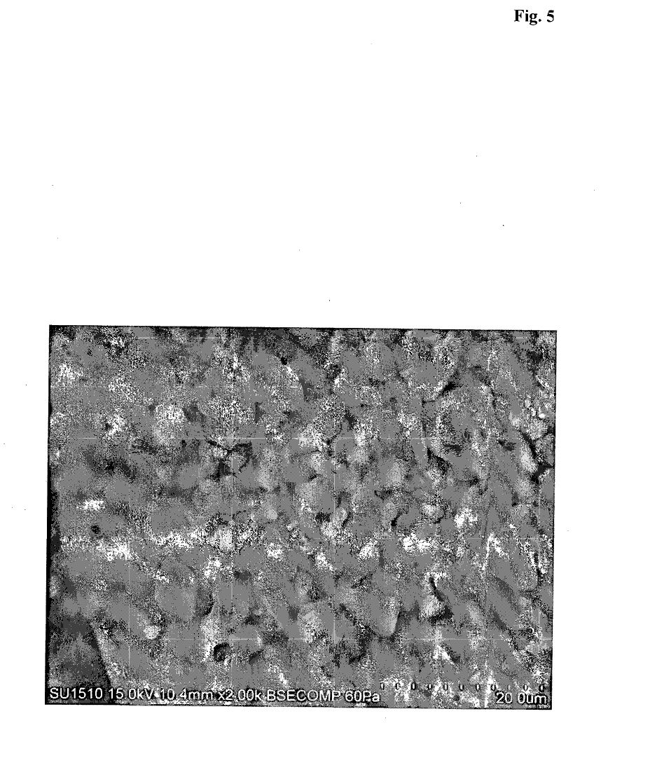

FIG. 6 shows a SEM image of substantially pure amorphous fosamprenavir calcium in magnification 10.5 mm×1000.

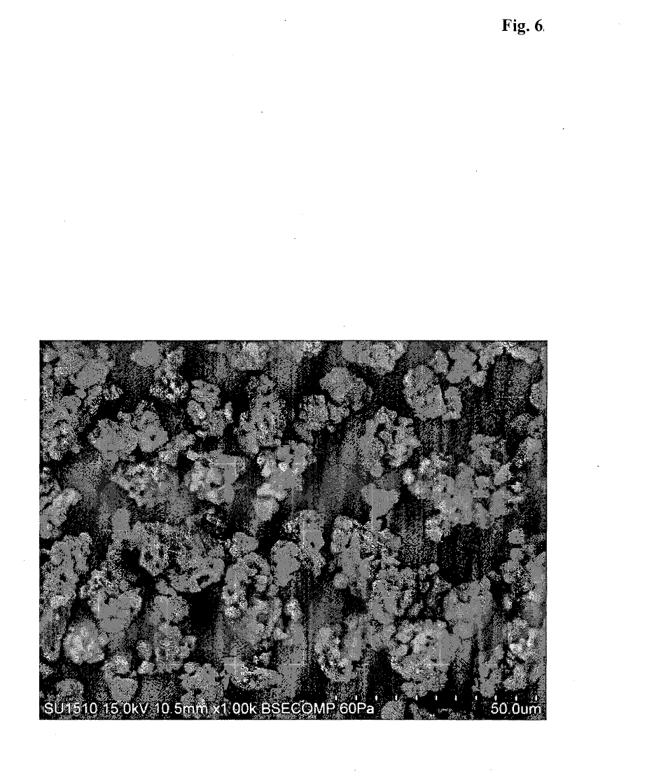

FIG. 7 shows a SEM image of substantially pure amorphous fosamprenavir calcium in magnification 10.5 mm×200.

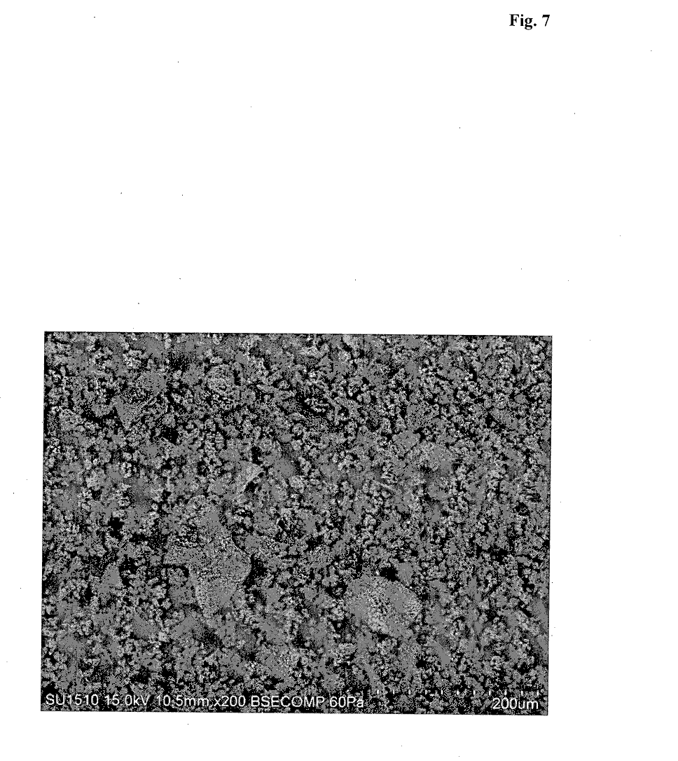

X-Ray Powder Diffractogram was measured on a bruker axs D8 advance X-ray powder diffractometer having a copper-Ka radiation. Approximately 500 mg of sample was gently flattered on a sample holder and scanned from 2 to 50 degrees two-theta, at 0.019 to 0.020 degrees two theta per step and a step time of 1 second. The sample was simply placed on the sample holder. The sample was rotated at 30 rpm at a voltage 40 KV and current 35 mA.

SEM micrographs are taken on HITACHI scanning microscope at 15 kV.

### DETAILED DESCRIPTION OF THE INVENTION

The term “room temperature” refers to temperature at about 25 to 35° C. According to one aspect of the present invention, there is provided a crystalline

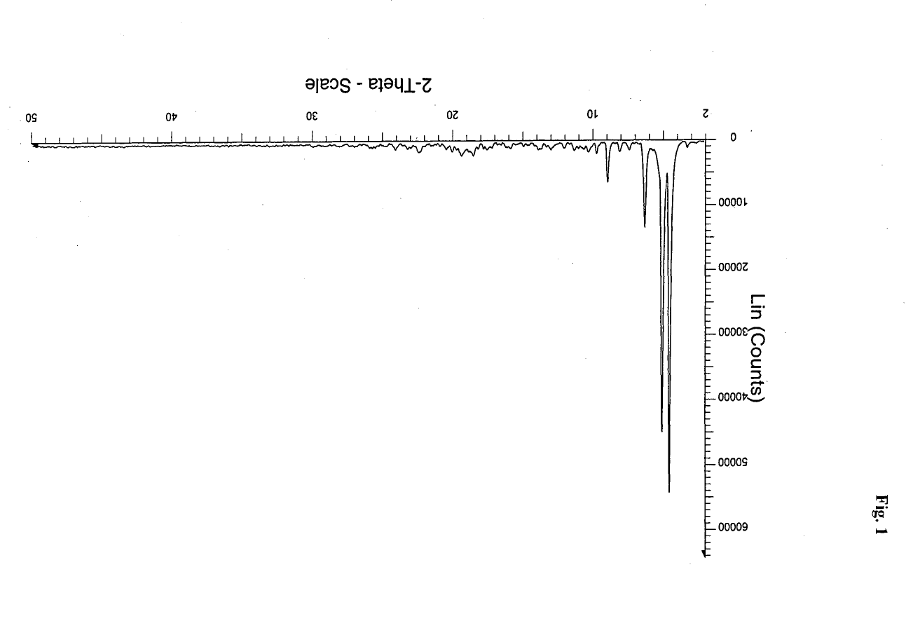

Form of fosamprenavir calcium designated as Form H1 characterized by peaks in the powder x-ray diffraction spectrum having 2θ angle positions at about 4.4, 5.0, 6.2 and 8.9±0.2 degrees. The powdered X-Ray Powder Diffractogram (XRPD) of fosamprenavir calcium crystalline Form H1 is shown in FIG. 1. to According to another aspect of the present invention, there is provided a process for the preparation of fosamprenavir calcium crystalline Form H1, which comprises:
a) suspending fosamprenavir calcium in a nitrile solvent;
b) heating the suspension obtained in step (a) at reflux;
c) optionally adding a solvent to the reaction mass obtained in step (b);
d) cooling the reaction mass at below 35° C.; and
e) isolating fosamprenavir calcium crystalline Form H1.

Fosamprenavir calcium used in step (a) may preferably be fosamprenavir calcium obtained by the known process.

The nitrile solvent used in step (a) may preferably be a solvent or mixture of solvents selected from acetonitrile, propionitrile, butyronitrile and benzonitrile. More preferably the nitrile solvent is acetonitrile.

The solvent used in step (c) may preferably be a solvent or mixture of solvents selected from tetrahydrofuran, 1,4-dioxane, methyl tert-butyl ether, diisopropyl ether, diethyl ether, cyclohexane, n-hexane, heptane, benzene, toluene, xylene and pentane. More preferably the solvents are heptane, cyclohexane, n-hexane, diisopropyl ether, methyl tert-butyl ether and pentane.

The step (d) may preferably be carried out at about −5 to 30° C. Fosamprenavir calcium crystalline form H1 may be isolated in step (e) by methods known such as filtration or centrifugation.

According to another aspect of the present invention, there is provided a pharmaceutical composition comprising crystalline Form H1 of fosamprenavir calcium and pharmaceutically acceptable excipients, and optionally other therapeutic ingredients. The crystalline Form HI may preferably be formulated into tablets, capsules, suspensions, dispersions, injectables or other pharmaceutical forms.

According to another aspect of the present invention, there is provided substantially pure amorphous fosamprenavir calcium. The powdered X-Ray Powder

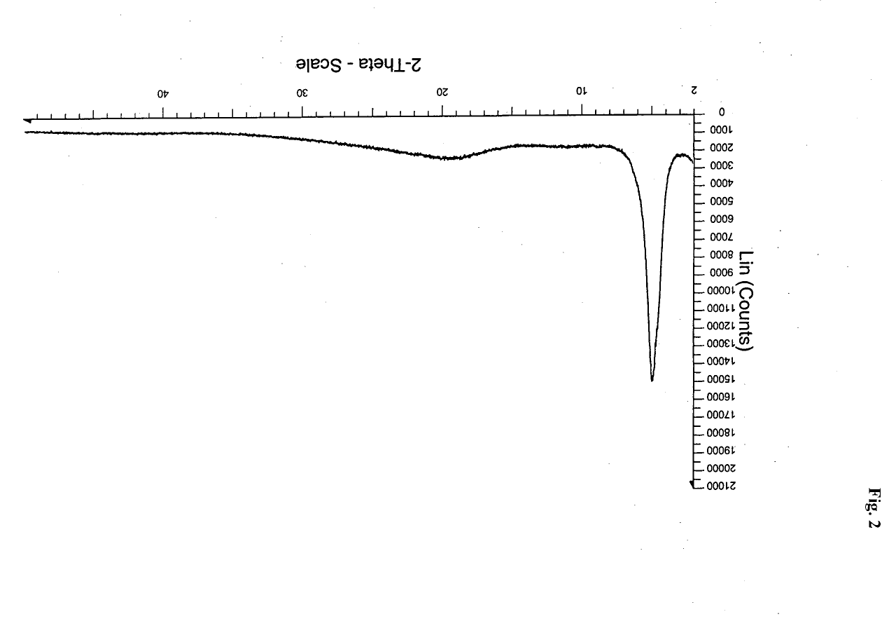

Diffractogram (XRPD) of substantially pure amorphous fosamprenavir calcium is shown in FIG. 2.

According to another aspect of the present invention, there is provided a process for the preparation of substantially pure amorphous fosamprenavir calcium, which comprises:
a) dissolving fosamprenavir calcium in an ester solvent;
b) a portion of solvent from the solution obtained in step (a) until at least separation of fosamprenavir calcium as solid occurs; and
c) isolating substantially pure amorphous fosamprenavir calcium.

The ester solvent used in step (a) may preferably be a solvent or mixture of solvents selected from ethyl acetate, methyl acetate, isopropyl acetate, tert-butyl methyl acetate and ethyl formate. More preferably the ester solvent is ethyl acetate.

The solvent may be removed from the solution in step (b) by known methods, for example, distillation or spray drying.

The distillation of the solvent may be carried out at atmospheric pressure or at reduced pressure. The distillation may preferably be carried out until the solvent is 50 percent distilled off.

Isolation of substantially pure amorphous fosamprenavir calcium in step (c) can be performed by conventional methods such as cooling, concentrating the reaction mass, adding an anti-solvent, extraction with a solvent and the like.

According to another aspect of the present invention, there is provided a pharmaceutical composition comprising substantially pure amorphous fosamprenavir calcium and pharmaceutically acceptable excipients, and optionally other therapeutic ingredients. The amorphous Form may preferably be formulated into tablets, capsules, suspensions, dispersions, injectables or other pharmaceutical forms.

The invention will now be further described by the following examples, which are illustrative rather than limiting.

### EXAMPLES

### Example 1

### Preparation of Fosamprenavir Calcium Crystalline Form H1

Fosamprenavir calcium (100 gm) was suspended in acetonitrile (1500 ml) at room temperature and then heated to reflux. The contents were stirred for 3 hours at reflux and then cooled to 30° C. The reaction mass was stirred for 2 hours at 30° C. and then further cooled to −5° C. The reaction mass was stirred for 3 hours at −5 to 0° C. and filtered. The solid obtained was dried to give 80 gm of fosamprenavir calcium crystalline Form H1.

### Example 2

### Preparation of Fosamprenavir Calcium Crystalline Form H1

Fosamprenavir calcium (100 gm) was suspended in acetonitrile (500 ml) at room temperature and then heated to reflux. The contents were stirred for 3 hours at reflux and then added heptane (500 ml). The reaction mass was then cooled to 30° C. and stirred for 3 hours at 30° C. The separated solid was filtered and dried to obtain 95 gm of fosamprenavir calcium crystalline Form H1.

### Example 3

### Preparation of Fosamprenavir Calcium Crystalline Form H1

Example 2 was repeated using cyclohexane solvent instead of heptane solvent to obtain fosamprenavir calcium crystalline Form H1.

### Example 4

### Preparation of Fosamprenavir Calcium Crystalline Form H1

Example 2 was repeated using n-hexane solvent instead of heptane solvent to obtain fosamprenavir calcium crystalline Form H1.

### Example 5

### Preparation of Fosamprenavir Calcium Crystalline Form

Example 2 was repeated using diisopropyl ether solvent instead of heptane solvent to obtain fosamprenavir calcium crystalline Form H1.

### Example 6

### Preparation of Fosamprenavir Calcium Crystalline Form H1

Example 2 was repeated using methyl tert-butyl ether solvent instead of heptane solvent to obtain fosamprenavir calcium crystalline Form H1.

### Example 7

### Preparation of Fosamprenavir Calcium Crystalline Form H1

Example 2 was repeated using pentane solvent instead of heptane solvent to obtain fosamprenavir calcium crystalline Form H1.

### Example 8

### Preparation of Amorphous Fosamprenavir Calcium

Fosamprenavir calcium (100 gm) was dissolved in ethyl acetate (1000 ml) at room temperature and 50 percent of the solvent volume was distilled off under atmospheric pressure at 75 to 80° C. to obtain a residual mass. The residual mass was co-distilled with ethyl acetate and maintained for 1 hour at 75 to 80° C. The contents were then cooled to room temperature and maintained for 2 hours at room temperature. The separated solid was filtered and then dried to obtain 95 gm of amorphous fosamprenavir calcium.

### Example 9

### Preparation of Amorphous Fosamprenavir Calcium

Example 8 was repeated using isopropyl acetate solvent instead of ethyl acetate solvent to obtain amorphous fosamprenavir calcium.

### Example 10

### Preparation of Amorphous Fosamprenavir Calcium

Example 8 was repeated using tert-butyl methyl acetate solvent instead of ethyl acetate solvent to obtain amorphous fosamprenavir calcium.

1. A fosamprenavir calcium crystalline Form H1 which is characterized by peaks in the powder x-ray diffraction spectrum having 2θ angle positions at about 4.4, 5.0, 6.2 and 8.9±0.2 degrees.

2. A fosamprenavir calcium crystalline Form H1 which is characterized by an X-Ray Powder Diffractogram as shown in FIG. 1.

3. A process for the preparation of fosamprenavir calcium crystalline Form H1 as claimed in claim 1, which comprises:
a. suspending fosamprenavir calcium in a nitrile solvent;
b. heating the suspension obtained in step (a) at reflux;
c. optionally adding a solvent to the reaction mass obtained in step (b);
d. cooling the reaction mass at below 35° C.; and
e. isolating fosamprenavir calcium crystalline Form Hl.

4. The process as claimed in claim 3, wherein the nitrile solvent used in step (a) is a solvent or mixture of solvents selected from acetonitrile, propionitrile, butyronitrile and benzonitrile.

5. The process as claimed in claim 4, wherein the nitrile solvent is acetonitrile.

6. The process as claimed in claim 3, wherein the solvent used in step (c) is a solvent or mixture of solvents selected from tetrahydrofuran, 1,4-dioxane, methyl tert-butyl ether, diisopropyl ether, diethyl ether, cyclohexane, n-hexane, heptane, benzene, toluene, xylene and pentane.

7. The process as claimed in claim 6, wherein the solvents are heptane, cyclohexane, n-hexane, diisopropyl ether, methyl tert-butyl ether and pentane.

8. (canceled)

9. (canceled)

10. A process for the preparation of substantially pure amorphous fosamprenavir calcium, comprising:
a. dissolving fosamprenavir calcium in an ester solvent;
b. removing a portion of the ester solvent from the solution obtained in step (a) until a separation of fosamprenavir calcium as a solid occurs; and
c. isolating the solid as substantially pure amorphous fosamprenavir calcium.

11. The process as claimed in claim 10, wherein the ester solvent used in step (a) is a solvent or mixture of solvents selected from ethyl acetate, methyl acetate, isopropyl acetate, tert-butyl methyl acetate and ethyl formate.

12. The process as claimed in claim 11, wherein the ester solvent is ethyl acetate.

13. The crystalline Form H1 of fosamprenavir calcium of claim 1 in the form of a pharmaceutical composition comprising a pharmaceutically acceptable excipient and in the form of a tablet or capsule.

14. (canceled)

15. (canceled)
